(19) United States
(12) Patent Application Publication
(10) Pub. No.: US 2016/0007161 A1
(43) Pub. Date: Jan. 7, 2016

(54) SYSTEM AND METHOD FOR DETECTION AND TRACKING OF WIRELESS ENABLED OBJECTS

(71) Applicant: QATAR UNIVERSITY QSTP-B, Al Gharrafa, Doha (QA)

(72) Inventor: Fethi FILALI, Doha (QA)

(21) Appl. No.: 14/441,844

(22) PCT Filed: Mar. 30, 2013
(86) PCT No.: PCT/IB2013/052574

§ 371 Date: May 9, 2015

(51) Int. Cl. H04W 4/02

(52) U.S. Cl. CPC H04W 4/025

(57) ABSTRACT

Disclosed is a system for detection and tracking of wireless enabled objects. The system comprises: a plurality of detectors; and a central server in operative communication with the plurality of detectors. Each of the plurality of detectors is capable of: detecting one or more wireless enabled objects; collecting associated information about the wireless enabled objects; and sending the associated information to the central server. The central server is capable of processing the associated information to produce analyzed data.

### FIELD OF THE INVENTION

The present invention relates to systems and methods for non-intrusive detection and tracking of wireless enabled objects.

### BACKGROUND OF THE INVENTION

Due to advent of wireless technologies, a myriad of wireless enabled objects have been introduced into the market. Such objects are generally capable of transferring data wirelessly and/or are capable of being detected wirelessly. Examples of such objects include mobile phones, wireless enabled car navigation systems, in-car wireless systems, wireless tags, and the like. Following introduction of such wireless enabled objects, a number of useful applications may be performed by detection and tracking of such objects. Few such useful applications include traffic control applications, transportation applications, security applications, and crowd management applications.

Existing systems used for tracking of wireless enabled objects, either intrusive or non-intrusive, suffer from high cost and/or low efficiency in attaining a desired result for an application. For example, camera-based tracking solutions are quite expensive and not very accurate in all weather conditions. Also, systems offering tracking in a large geographical area are not available. Even if tracking in a large geographical area is feasible, it is too expensive to dilute the usefulness of the application.

Accordingly, there is a need for a system that can detect and track wireless enabled objects in a cost efficient and reliable manner to implement useful applications.

### SUMMARY OF THE INVENTION

In view of the foregoing disadvantages inherent in the prior-art, the general purpose of the present invention is to provide a method and a system for non-intrusive discovering and tracking wireless-equipped moving objects that is configured to include all advantages of the prior art and to overcome the drawbacks inherent in the prior art offering some added advantages.

In one aspect, the present invention provides a system for detection and tracking of wireless enabled objects. The system comprises: a plurality of detectors; and a central server in operative communication with the plurality of detectors. Each of the plurality of detectors is capable of: detecting one or more wireless enabled objects; collecting associated information about the wireless enabled objects; and sending the associated information to the central server. The central server is capable of processing the associated information to produce analyzed data.

In another aspect, the present invention provides a system comprising a plurality of detectors capable of detecting one or more wireless objects and storing the associated information in a memory of each of the detectors. In such there may be no mandatory requirement of sending the associated information to a central server; and instead the associated information may be processed in one of the modes: memory of the detector in form a removable memory unit that can be dynamically installed and removed to be processed on another server; retrieval of associated information by a passing by wireless enabled device to be processed by wireless device itself or to be carried to be processed at another server; and a mode in which the associated information is processed at the detector itself and retrieved by a passing by wireless enabled device.

In another aspect, the present invention provides a method for detection and tracking of wireless enabled objects. The method comprises: scanning and detecting wireless enabled objects by one or more wireless communication modules of a plurality of detectors; collecting associated information about the wireless enabled objects; sending the associated information to a central server; and processing of associated information by the central server to produce analyzed data.

These together with other aspects of the invention, along with the various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there are illustrated exemplary embodiments of the invention.

### BRIEF DESCRIPTION OF THE DRAWINGS

While the specification concludes with claims that particularly point out and distinctly claim the invention, it is believed that the advantages and features of the present invention will become better understood with reference to the following more detailed description of expressly disclosed exemplary embodiments taken in conjunction with the accompanying drawings. The drawings and detailed description which follow are intended to be merely illustrative of the expressly disclosed exemplary embodiments and are not intended to limit the scope of the present invention as set forth in the appended claims. In the drawings:

FIG. 1 depicts an overview of a system for detection and tracking of wireless enabled objects, according to an exemplary embodiment of the present invention;

FIG. 2 is a block diagram of a detector, according to an embodiment of the present invention;

FIG. 3 is a block diagram of the detector of FIG. 2 with specific wireless communication modules, according to an embodiment of the present invention;

FIG. 4 illustrates a method for initializing the detector, according to an embodiment of the present invention;

FIG. 5 illustrates a method for detection and tracking of wireless enabled objects, according to an embodiment of the present invention;

FIG. 6 illustrates an application of the system of FIG. 1 showing detection and tracking of wireless enabled objects, according to an embodiment of the present invention;

FIG. 7 is a table illustrating the processing based on the detected information; and

FIG. 8 illustrates a flowchart for detecting a high speed moving wireless enabled object using two Bluetooth modules.

Like reference numerals refer to like parts throughout the several views of the drawings.

### DETAILED DESCRIPTION OF THE INVENTION

The exemplary embodiments described herein detail for illustrative purposes are subject to many variations in structure and design. It should be emphasized, however, that the present invention is not limited to a particular method and system for detection and tracking of wireless enabled objects, as shown and described. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting.

In the following description, for purposes of explanation, numerous specific details are set forth in order to provide a thorough understanding of the present invention. It will be apparent, however, to one skilled in the art that the present invention may be practiced without these specific details.

In an exemplary embodiment, the present invention provides systems and methods for non-intrusive detection and tracking of wireless enabled objects. The system of the present invention may be mass produced inexpensively and used in an easy, robust, efficient, secure, cost effective, environment friendly and productive way.

The use of terms “including”, “comprising”, or “having” and variations thereof herein are meant to encompass the items listed thereafter and equivalents thereof as well as additional items. Further, the terms, “a” and “an” herein do not denote a limitation of quantity, but rather denote the presence of at least one of the referenced item.

The present invention provides systems and methods for non-intrusive detection and tracking of wireless enabled objects. Pursuant to an exemplary scenario, the detection and tracking of wireless enabled objects involves detector for detecting all wireless enabled moving objects using wireless communication technologies. The system of the present invention primarily comprises a plurality of detectors and an optional central server. The detector sends the information associated with the wireless enabled objects (hereinafter referred to as ‘associated information’) to the central server. As used herein, associated information refers to, but is not limited to, identifier detail, location timestamp, frequencies of the wireless enabled objects, and the like.

The central server receives, processes, filters, stores and analyses the associated information to produce analyzed data. Such analyzed data can be in form of analytical reports that can be efficiently applied in many areas, including but not limited to, transportation, security and crowd management.

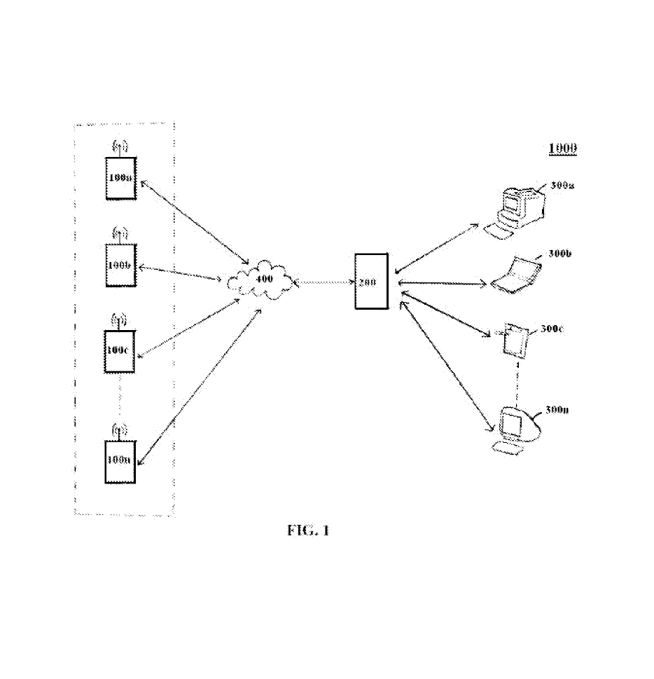

Also, such analyzed data can be accessed through user applications installed on user interfaces. Such user applications may be used in visualizing the analyzed data, configuring components in the system based on the analyzed data, monitoring the detectors, and the like. Various embodiments of the present technology, however, provide method and system for non-intrusive detection and tracking of wireless enabled objects that are capable of overcoming these and other obstacles and providing additional benefits. An environment for detection and tracking of wireless enabled objects is explained with reference to FIG. 1.

As used herein, the user application may be in form of a software application designed to run on personal computers, a laptops, tablets, personal digital assistants, mobile communication devices and the like.

As used herein, ‘wireless enabled objects’ refer to objects which comprise a wireless communication module such that they can transfer data wirelessly or can be detected wirelessly. Examples of wireless enabled objects include, but are not limited to, mobile phones, wireless-enabled car navigation systems, in car wireless systems, wireless tags, or any other object which is enabled by wireless technology. Examples of the wireless technologies may include but are not limited to Bluetooth, Wi-Fi, 802.11p, NFC, ZigBee, GPRS, GPS and the like.

As used herein, Bluetooth refers to the wireless technology standard for exchanging data over short distances from fixed and mobile devices, creating personal area networks (PANs) with high levels of security. It can connect several devices, overcoming problems of synchronization.

As used herein, Wi-Fi refers to the technology that allows an electronic device to exchange data wirelessly (using radio waves) over a computer network, including high-speed Internet connections.

As used herein, 802.11p refers to the wireless access in vehicular environments (WAVE) required to support Intelligent Transportation Systems (ITS) applications which includes data exchange between high-speed vehicles and between the vehicles and the roadside infrastructure.

As used herein, NFC refers to the Near field communication wherein smartphones and similar devices establish radio communication with each other by touching them together or bringing them into close proximity, usually no more than a few centimeters.

As used herein, ZigBee refers to the specification for a suite of high level communication protocols using small, low-power digital radios based on an IEEE 802 standard for personal area networks.

As used herein, GPRS refers to the General packet radio service used for packet oriented mobile data service available to users of the 2G cellular communication systems global system for mobile communications (GSM) and Global Positioning System that provides location and time information in all weather conditions, anywhere on or near the Earth where there is an unobstructed line of sight to four or more GPS satellites respectively.

As used herein, GPS refers to the Global Positioning System that provides location and time information in all weather conditions, anywhere on or near the Earth where there is an unobstructed line of sight to four or more GPS satellites.

FIG. 1 depicts an overview of a system 1000 for detection and tracking of wireless enabled objects, according to an embodiment of the present invention. The system 1000 comprises a plurality of detectors 100a-100n (hereinafter individually and collectively referred to as the detector 100) and a central server 200. The detector 100 is capable of detecting wireless enabled objects and collecting the associated information about the wireless enabled objects. Further, the detector is capable of sending the associated information to the central server.

The detector 100 can be installed at strategic positions in a monitored geographical area. Specifically, the detector 100 can be installed at a fixed location either as a standalone object or installed in an already existing object (for example, traffic signal). Alternatively, or in addition, the detector 100 can be mobile by installing the detector 100 in moving objects. Examples of moving objects may include but are not limited to motor vehicles, trains, airplanes, and the like.

The detector 100 sends the associated information detected by the detector 100 to the central server 200 over a network 400. In an embodiment, the central server 200 may be one of a general purpose computing device, a cluster of servers, a blade server, a virtual machine environment and a mainframe, or a combination of any of the foregoing.

Examples of the network 400 may include wired networks, wireless networks or a combination thereof. An example of a wired network may be a local area network (LAN), fiber optic. Examples of wireless networks may include cellular networks, wireless LANs, Zigbee networks, dial-on modem, and the like. A combination of the wired network and wireless network may include Internet, which may use any of the above-mentioned networks for enabling access to the detector 100 and central server 200.

The central server 200 receives the associated information from the detector 100. Thereafter, the central server 200 processes the associated information, filters it, stores it and analyses the associated information to produce useful analyzed data. Such analyzed data can be in form of reports and other outputs that are useful to personnel for concluding and configuring on many aspects of transportation and security and other application fields. Analyzed data can also be custom prepared based on user requirements and/or requirements for a particular application. For example, a user requiring to know the traffic condition will be provided a report comprising different route options with time taken to reach his/her destination arranged in order of least amount of time taken.

Such analyzed data can be accessed through user applications installed on user interfaces 300a-300n; hereinafter, individually or collectively, referred to as user interface 300.

The user interface 300 may be configured to include a proprietary interface, which may be utilized for establishing communication with the central server 200. Examples of user interface 300 may include devices such as personal computers, laptops, tablets, personal digital assistants, mobile communication devices and the like. The user application may be installed on such devices. Running the user application will provide a user with following applications that include, but are not limited to, visualizing the analyzed data, configuring system components, reporting administrators, generating and sharing analyses reports with other users, and monitoring the detectors.

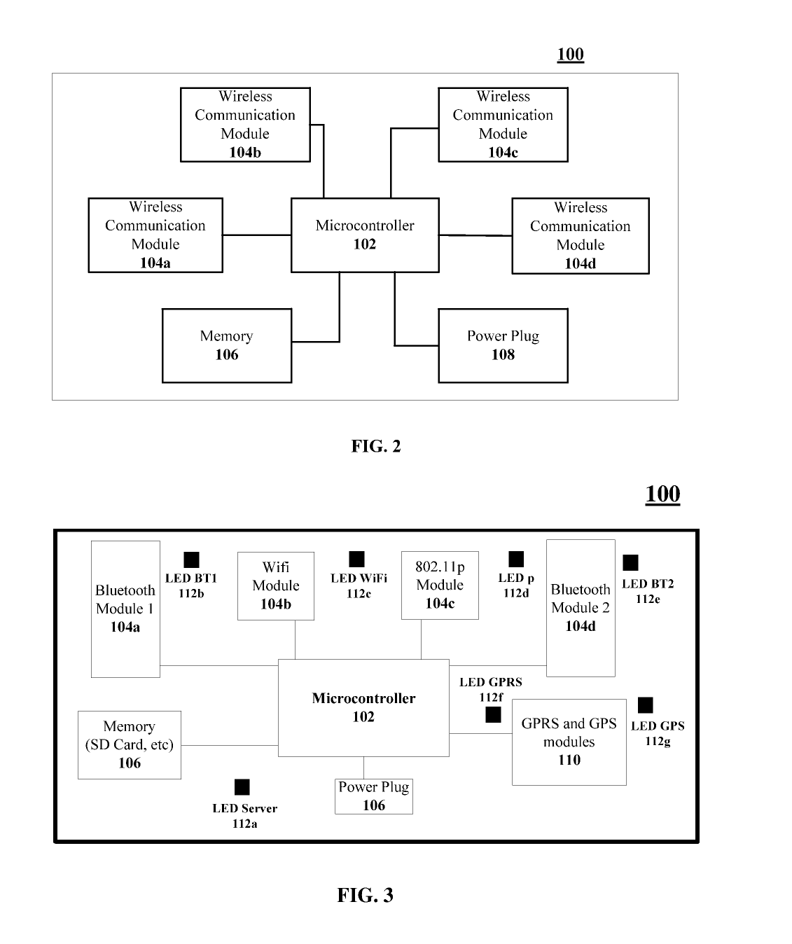

FIG. 2 is a block diagram of the detector 100 which illustrates the different components of the detector 100. As shown herein, the detector 100 comprises a microcontroller 102. A plurality of wireless communication modules 104a, 104b, 104c, 104d (herein collectively referred to as 104) are operatively coupled to the microcontroller 102. Further, the detector comprises a memory 106 operatively coupled to the microcontroller 102. The detector 100 also comprises a power plug 108 through which power is supplied to the detector 100. Power can be supplied to the detector 100 using a standard power grid. In an alternate embodiment, power can be supplied to the detector using a solar panel based power system. In cases, where the detector is installed in moving objects (for example, automobiles), the power can be supplied to the detector 100 by using power sources that are operating the automobiles.

The microcontroller 102 is capable of: gathering the associated information of the detected wireless enabled objects; and sending the associated information to the central server 200. As illustrated in FIG. 2, multiple wireless communication modules 104a, 104b, 104c, 104d are present in the detector 100. In one embodiment, the microcontroller 102 is capable of gathering associated information from two or more wireless communication modules at the same time and creating a single data record for either storing in the memory 106 or sending to the central server 200.

As used herein, the microcontroller 102 is in the form of a small computer on a single integrated circuit containing a processor core, memory, and programmable input/output peripherals which are used in automatically controlled products and devices, such as automobile engine control systems, implantable medical devices, remote controls, office machines, appliances, power tools, toys and other embedded systems.

The detector is configured to include multiple wireless communication modules, for example, Bluetooth modules, Wi-Fi modules, 802.11p modules, NFC modules, ZigBee modules, and similar wireless communication modules. Specifically, Bluetooth modules may be used for detecting moving objects containing Bluetooth signal. The Wi-Fi modules may be used for detecting the moving objects containing Wi-Fi signal. The 802.11p modules may be used for detecting the moving objects containing 802.11p signal. The NFC modules may be used for detecting the moving objects containing NFC signal. The ZigBee modules may be used for detecting the moving objects containing ZigBee signal

The memory 106 is capable of logging the data or information detected from the different wireless communication modules. The memory 106 is a physical device used to store programs (sequences of instructions) or data (e.g. program state information) on a temporary or permanent basis for use in a computer or other digital electronic device. Examples of the memory include, but are not limited to, PC Card, Secure Digital card, miniSD card, microSD card, flash memory. The said memory in the detector 100 will always contain the most recent associated information in regard to the detected moving wireless enabled objects.

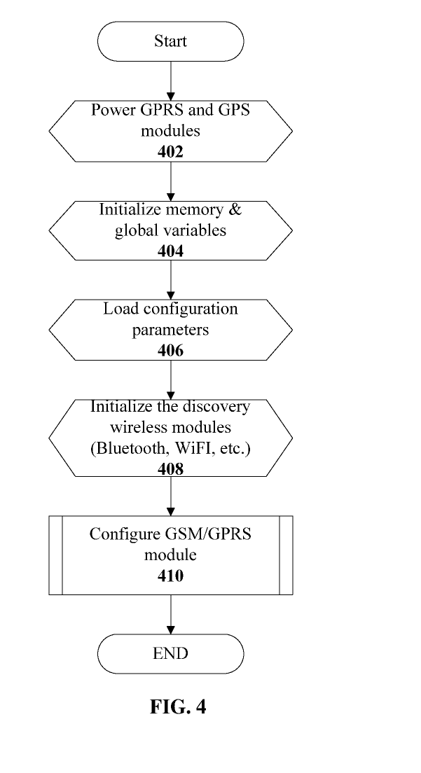

FIG. 3 illustrates the different specific components of the detector 100 as explained in FIG. 2 according to an exemplary embodiment of the present invention. As shown herein, the detector 100 comprises a microcontroller 102. A plurality of wireless communication modules 104a, 104b, 104c, 104d (herein collectively referred to as 104) is operatively coupled to the microcontroller 102. The modules 104a and 104d are the Bluetooth modules which are used for detecting the moving objects containing Bluetooth signal. The module 104b is the Wi-Fi module which is used for detecting the moving objects containing Wi-Fi signal. The module 104c is the 802.11p module which is used for detecting the moving objects containing 802.11p signal. A memory 106 operatively coupled to the microcontroller 102. A GPRS and GPS module 110 is operatively coupled to the microcontroller 102. Further, the detector 100 comprises a plurality of LED modules 112a, 112b, 112c, 112d, 112e, 112f, 112g (herein collectively referred to as 112).

The LED 112a is capable of indicating whether the detector 100 and the central server 200 are actively connected. For example, the LED 112a glows to indicate an active connection between the detector 100 and the central server 200. Alternatively, when the LED 112a does not glow, then there is no active connection between the detector 100 and the central server 200. Similarly LED 112b, LED 112c, LED 112d, LED 112e, LED 112f, LED 112g indicates the activeness and de-activeness of the respective modules 104a, 104b, 104c, 104d and GPRS and GPS module 110 respectively.

In an embodiment as illustrated in FIG. 3, each of the plurality of detectors further comprises a GPRS and GPS module that can be used for communication with a user interface via the central server 200. The detector 100 is configured to be included with microcontroller 102 in connection with the GPRS and GPS modules 110 which is used to detect the moving objects when the detector 100 is installed in the moving object.

User can communicate with the detector 100 via the central server 200 using the GPRS and GPS module 110. In an embodiment as illustrated the GPRS and GPS module 110 used herein supports over the air configuration wherein a user can send SMS to the detector 100 to read or modify the current configuration of the detector 100 and also upgrade it accordingly. Further, voltage at the power plug 108 can also be determined by the SMS response.

As used herein, the current configuration refers to the details in the central server 200 in regard to the detector which may include but are not limited to the detector id, detector description, detector installation date, and the detector orientation. As used herein, detector id refers to the associated identification assigned to the each of the detector. As used herein, the detector description may refer all details on the detector 100 that are useful in determining location, type, and functioning of the detector 100. As used herein, detector installation date refers to the date and time when the detector 100 was installed and was operational. As used herein detector orientation refers to the information including, but not limited to, location latitude of the detector 100, location altitude of the detector 100, and location longitude of the detector.

The detector 100 of the present invention is capable of being operated in three modes for sending the associated information from detector 100 to the central server 200. In a first mode, the detector 100 operates to send the associated information of the wireless objects to the central server 200 immediately on a real time basis, i.e., associated information is sent as soon as the wireless enabled object is detected. In a second mode, the detector 100 operates to send the associated information on the discovered objects to the central server 200 only after they are out of range of the discovery area of the detector. In a third mode, the detector 100 may operate in a mode wherein the detector can store the detected information in the memory 106 instead of sending the same in real time to the central server 200. In this operation mode, the data is collected in the memory 106 and periodically (weekly or monthly) sent to the central server 200.

The detector 100 can also operate in a combination of all the above-described modes. Such a combination mode may result in redundant data, however, may be useful for backup/security purposes when data collected via one of the modes is corrupted.

In an alternate embodiment, the present invention provides a system comprising a plurality of detectors capable of detecting one or more wireless objects and storing the associated information in a memory of each of the detectors. In such there may be no mandatory requirement of sending the associated information to a central server; and instead the associated information may be processed in one of the modes: memory of the detector in form a removable memory unit that can be dynamically installed and removed to be processed on another server; retrieval of associated information by a passing by wireless enabled device to be processed by wireless device itself or to be carried to be processed at another server; and a mode in which the associated information is processed at the detector itself and retrieved by a passing by wireless enabled device.

As used herein, “wireless enabled device” may refers to one of the wireless enabled objects, or, alternatively to another device that may be specifically configured to be capable of retrieving associated information from the detectors.

In an embodiment as illustrated in FIG. 1 the detector 100 uses the non-intrusive technology, wherein the detector 100 is not able to detect individual and individual's private information such as phone number, vehicle plate number, etc. Further there is no use of the radar or camera for the detection of the said wireless enabled moving objects. Technique herein used for the detection of the wireless enabled moving object is Media Access Control address. As mentioned herein Media Access Control address refers to the associated identifier assigned to network interfaces for communications on the physical network segment. The Media Access Control address is not associated with any specific user account (as in the case with cell phone probes) or any specific vehicle (as with automated toll tags) further, is not linked to a specific person through any central database. The said detector 100 does not communicate or try to pair with the detected Bluetooth devices. The said detector 100 herein with Media Access Control gives only the hardware address of the moving objects. The detector 100 herein detects the wireless-enabled objects moving objects and creates the Media Access Control address. As mentioned herein the Media Access Control address is thereafter framed into the data packet along with the time stamp. Time stamp in the data packet represents the time of the detection of the wireless device in a moving object for the last time in the specified range covered by the detector 100. The central server 200 encrypts the received Media Access Control address using standard hashing algorithms and stores only encrypted identifiers which cannot be linked to the actual Media Access Control address.

In an embodiment as illustrated in FIG. 1 in system 1000 the sending an associated information from detector 100 to central server 200 comprises filtering of data wherein the data sent to central server 200 comprises of only the data that are potentially in moving condition. As mentioned herein associated information refers to but not limited to identifier, frequencies of the wireless enabled objects and the like

FIG. 4 illustrates a flow diagram of a method 400 for initialization of the detector 100. The method 400 depicted in flow diagram may be executed by, for the detector 100 of FIGS. 2 and 3. Operations of the flowchart, and combinations of operation in the flowchart, may be implemented by various means, such as hardware, firmware, processor, circuitry and/or other device associated with execution of software including one or more computer program instructions. The operations of the method 400 are described with help of the detector 100. However, the operations of the method 400 can be described and/or practiced by using any other detector. The method 400 starts at operation 402.

At 402, the GPRS and GPS module 110 as depicted in FIG. 3 are powered to bring the module in an active mode. At 404, the memory 106 is initialized and bought in the active mode along with initializing global variables. As described above, the memory 106 is in form of an internal memory that stores information on detection and tracking before the same is transmitted to the central server 200.

At 406, the configuration parameters are loaded for detecting and tracking the wireless enabled objects. At 408, the wireless communication modules 104 are initialized and activated so that they can detect wireless enabled objects. At 410, the GPRS and GPS module 110 is configured for sending the associated information regarding the wireless enabled moving objects.

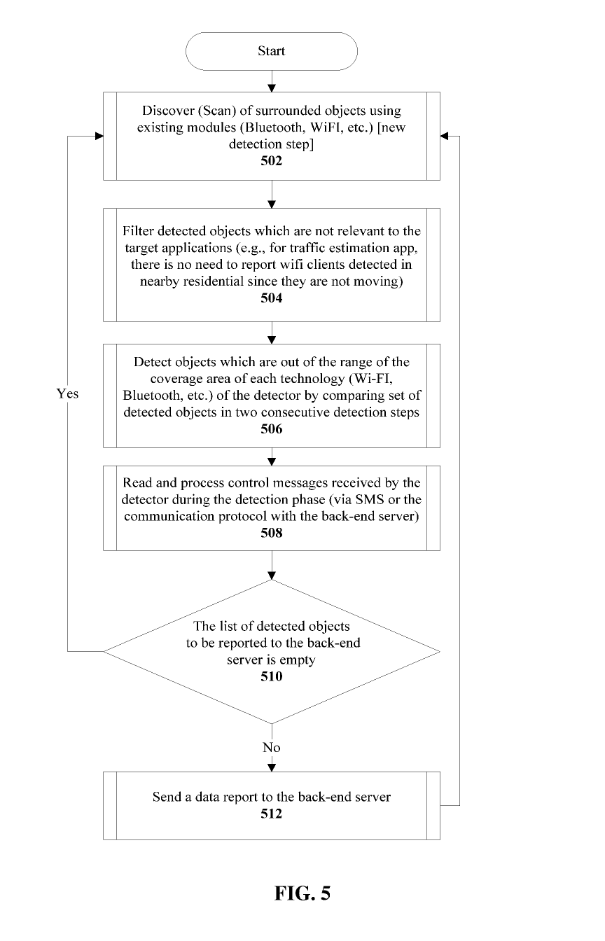

FIG. 5 illustrates a flow diagram of a method 500 for detection and reporting method of moving wireless enabled objects according to an embodiment of the present invention. The method 500 depicted in flow diagram may be executed by, for example, the system 1000 of FIG. 1. Operations of the flowchart, and combinations of operation in the flowchart, may be implemented by various means, such as hardware, firmware, processor, circuitry and/or other device associated with execution of software including one or more computer program instructions. The operations of the method 500 are described with help of the system 1000 of FIG. 1. However, the operations of the method 500 can be described and/or practiced by using any other system. The method 500 starts at operation 502.

At 502, the detector 100 as mentioned in FIG. 1 scans and detects at least one wireless enabled object with the help of wireless communication modules 104 as mentioned in FIG. 2. The detection of the wireless enabled object with the help of wireless communication modules is explained in reference to FIG. 2 and is not explained herein.

At 504, the detector 100 as mentioned in FIG. 1 filters the detected moving objects associated information which are not relevant to the target application (e.g. for traffic estimation application, there is no need to report Wi-Fi clients detected in nearby residential area since they are not moving). As used herein filtration of the detected moving object comprises of Media Access Control address which gives only the hardware address of the moving objects and don't give the Media Access Control address of the objects which are not moving.

At 506, the detector 100 as mentioned in FIG. 1 detects at least one wireless enabled object which is out of the coverage area of the mentioned wireless communication modules 104 as mentioned in FIG. 2. The detection of the wireless enabled object with the help of wireless communication modules is explained in reference to FIG. 2 and is not explained herein.

At 508, the detector 100 as mentioned in FIG. 1 detects the associated information regarding the wireless enabled objects and processes the said associated information with respect to the information received from the central server 200. The information received from the central server 200 to the detector is through the network 400 as explained in FIG. 1 and is not explained herein.

At 510, if the detector 100 as mentioned in FIG. 1 detects the associated information regarding the wireless enabled objects then the detector 100 sends the associated information to central server 200 over the network 400 as mentioned in FIG. 1. If the detector 100 as mentioned in FIG. 1 detects no associated information then the said detector 100 starts again with the method as explained at 502, 504, 506, 508 of method 500 and is not explained herein.

At 512, if the detector 100 as mentioned in FIG. 1 detects the associated information regarding the wireless enabled objects; thereafter the detector 100 sends the associated information to central server 200 over the network 400 as mentioned in FIG. 1. The said detector 100 starts again with the method as explained at 502, 504, 506, 508, 510 of method 500.

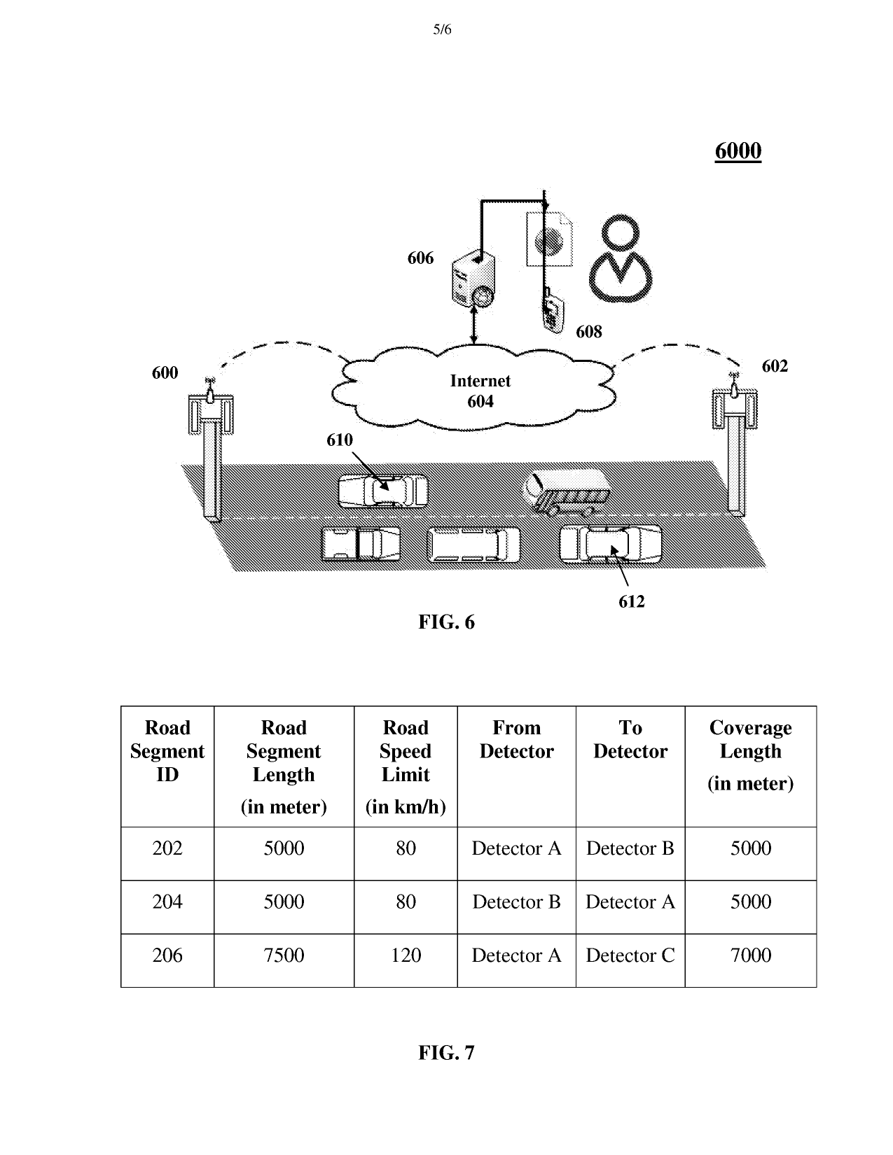

FIG. 6 illustrates one of an application of the said invention in a road traffic system 6000. The road traffic system 6000 consists of two detectors 600 and 602, the communicating system 604, the central server 606, the user interface 608 and moving wireless enabled moving objects 610 and 612. The said two detectors 600 and 602 are installed in the same road segment. The detectors 600 and 602 may be powered using the solar panel or standard power grid as discussed earlier. In the said application two detectors 600 and 602 detects the moving objects 610 and 612 with the help of the module 104 as mentioned for detector 100 in FIG. 2. The associated information detected from these detectors 600 and 602 are sent to the central server 606 via network 604. The central server 606 analyses, filters the data received which can be used by different user interfaces such as in web application, mobile applications and the like.

Other applications of the said invention may comprise in open or closed geographical area and are not limited to security purposes, transportation purposes, crowd management, safety, Origination-Destination studies, estimating the number of passengers in the bus, airplanes, airports, shopping malls, vehicle infrastructure communication and the like.

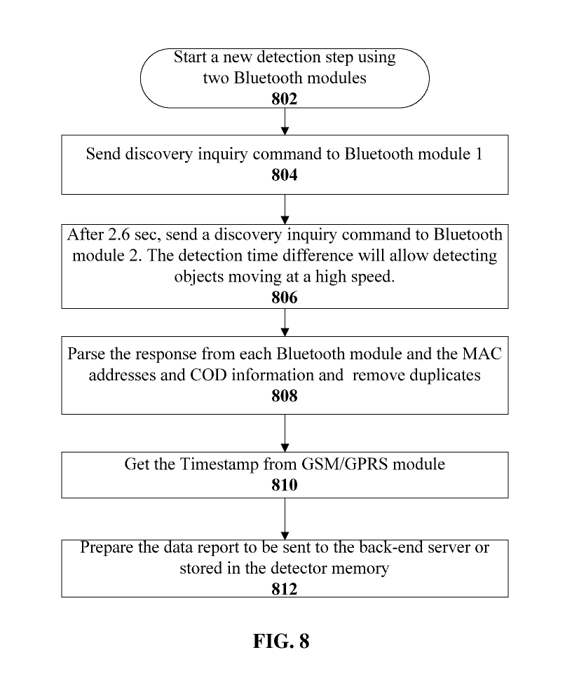

FIG. 7 is table illustrating the processing based on the detected information for road traffic congestion estimation system 7000. Herein one or more detectors 100 as mentioned in FIG. 1 are associated together to detect matched pairs in road segments. The detector 100 detect the wireless enabled moving objects and send the associated information to the central server 200 as mentioned in FIG. 1. The central server 200 as mentioned in FIG. 1 determines the matched pairs of wireless enabled moving objects. If the same object is detected by one or more associated detectors 100 as mentioned in FIG. 1 associated to the same road segment, then the central server 200 as mentioned in FIG. 1 is able to compute the travel time of the object between these detectors and hence deduce the travel time in the road segment. The table in FIG. 7 shows the associated information wherein road segment ID is the ID for the road segment where the wireless enabled object is moving. The road segment length is the full length of the road segment. Road speed limit is the speed by which the wireless enabled moving objects is moving from one detector to another detector in the coverage area of the said detectors.

FIG. 8 illustrates a flowchart for detecting a high speed wireless enabled moving object using two Bluetooth modules. Using two Bluetooth modules enables the detector to detect the wireless enabled objects for the range of 100 meters or more and increases the probability of getting the Bluetooth devices detected in the vicinity of the detector. At 802, the detector 100 as mentioned in FIG. 3 starts the new detection step by using two Bluetooth modules 104a and 104d as mentioned in FIG. 3. At 804, one of the Bluetooth modules activates and detects the wireless enabled high speed moving object. At 806, after 2.6 seconds the second Bluetooth module activates and detects the wireless enabled high speed moving object. The detection time difference between the said two Bluetooth modules 104a and 104d as mentioned in FIG. 3 will help in detecting the wireless enabled objects moving at very high speed, for example, the speed of up to 260 kmph. At 808, the detector 100 as mentioned in FIG. 3 examines the response from each of the Bluetooth module 104a and 104d as mentioned in FIG. 3, examines the Media Access Control address and COD information and removes the duplicate values if detected by the detector 100 as mentioned in FIG. 3. At 810, the detector detects the timestamp for the wireless enabled moving objects with the help of the GPRS and GPS module 110, as mentioned in FIG. 3 present in the detector 100. At 812 all the associated information received during the method from 802 till 810 in regard to the high speed wireless enabled moving objects are sent to the central server 200 as mentioned in FIG. 1 for processing or stored in the detector memory 106 as mentioned in FIG. 3.

Without in any way limiting the scope, interpretation, or application of the claims appearing below, advantages of one or more of the exemplary embodiments disclosed herein provides a method and system for non-intrusive detection and tracking of wireless enabled objects without detecting individual private information such as phone number, vehicle plate number and the like.

Additionally, there is no need of the camera or radar to be integrated with the detectors for detection and tracking of wireless enabled objects.

The detector herein does not communicate or try to pair with detected Bluetooth devices since what it does is only discovering them and try to determine the hardware addresses.

Further, as described method and system for non-intrusive detection and tracking of wireless enabled objects is cost-effective and efficient. In conventional tracking system, camera based solutions were used, which are expensive and not very accurate in all weather conditions.

Also, techniques, devices, subsystems and methods described and illustrated in the various embodiments as discrete or separate may be combined or integrated with other systems, modules, techniques, or methods without departing from the scope of the present technology. Other items shown or discussed as directly coupled or communicating with each other may be coupled through some interface or device, such that the items may no longer be considered directly coupled to each other but may still be indirectly coupled and in communication, whether electrically, mechanically, or otherwise, with one another. Other examples of changes, substitutions, and alterations ascertainable by one skilled in the art, upon studying the exemplary embodiments disclosed herein, may be made without departing from the spirit and scope of the present technology.

In various exemplary embodiments of the present invention, the method discussed herein, e.g., with reference to FIGS. 1 to 8, may be supplemented with operations implemented through computing devices such as hardware, software, firmware, or combinations thereof, which may be provided as a computer program product, e.g., including a machine-readable or computer-readable medium having stored thereon instructions or software procedures used to program a computer to perform a process discussed herein. The machine-readable medium may include a storage device.

In other instances, well-known devices, methods, procedures, components, and circuits have not been described herein so as not to obscure the particular embodiments of the present invention. Further, various aspects of embodiments of the present invention may be performed using various means, such as integrated semiconductor circuits, computer-readable instructions organized into one or more programs, or some combination of hardware and software.

It should be noted that reference throughout this specification to features, advantages, or similar language does not imply that all of the features and advantages should be or are in any single embodiment. Rather, language referring to the features and advantages may be understood to mean that a specific feature, advantage, or characteristic described in connection with an embodiment may be included in at least one embodiment of the present technology. Thus, discussions of the features and advantages, and similar language, throughout this specification may, but do not necessarily, refer to the same embodiment.

We claim:

1. A system for detection and tracking of wireless enabled objects, comprising:
a plurality of detectors; and
a central server in operative communication with the plurality of detectors;
wherein each of the plurality of detectors is capable of
detecting one or more wireless enabled objects,
collecting associated information about the wireless enabled objects, and
sending the associated information to the central server; and
wherein the central server is capable of processing the associated information to produce analyzed data.

2. The system of claim 1, further comprising one or more user interfaces, wherein each user interface is installed with a user application.

3. The system of claim 2, the one or more user interfaces are at least one of a personal computer, a laptop, a tablet, a personal digital assistant and a mobile communication device.

4. The system of claim 1, wherein each of the plurality of detectors comprises:
a microcontroller;
one or more wireless communication modules operatively coupled to the microcontroller,
wherein the one or more wireless communication modules are capable of detecting the wireless enabled objects; and
wherein the microcontroller is capable of
gathering the associated information of the detected wireless enabled objects, and
sending the associated information to the central server.

5. The system of claim 4, wherein the microcontroller is capable of gathering associated information from one or more wireless communication modules and creating a single data record to be sent to the central server.

6. The system of claim 4, each of the one or more wireless communication modules is one of a Bluetooth module, Wi-Fi module, 802.11p module, NFC module, and a Zigbee module.

7. The system of claim 4, wherein each of the plurality of detectors further comprises a memory operatively coupled to the microcontroller to store the associated information.

8. The system of claim 4, wherein each of the plurality of detectors further comprises a power plug for supplying power to the detector.

9. The system of claim 4, wherein each of the plurality of detectors further comprises a GPRS and GPS module operatively coupled to the microcontroller, and wherein a user can communicate with the detector via the central server using the GPRS and GPS module.

10. The system of claim 1, wherein the plurality of detectors are installed at fixed locations or in moving objects or a combination of the foregoing.

11. The system of claim 10, wherein the plurality of detectors are installed at a standalone position or in an existing object or a combination of the foregoing.

12. The system of claim 1, wherein each of the plurality of detectors send the associated information to the central server in at least one of the following modes:
a first mode wherein the detector sends the associated information of the wireless enabled objects to the central server immediately on a real time basis;
a second mode wherein the detector sends the associated information upon the wireless enabled objects being out of the coverage area of the detector; and
a third mode wherein the detector stores the associated information and send the associated information on a predetermined periodical basis.

13. The system of claim 4, wherein the detectors are capable of detecting wireless enabled objects moving at a speed of up to 260 kmph.

14. The system of claim 13, wherein the detector comprises two or more wireless communication modules for scanning the wireless enabled objects at different times for detection of the wireless enabled objects.

15. The system of claim 1, wherein the detector is powered using at least one of a standard power grid system and a solar panel based power system.

16. The system of claim 1, wherein the associated information comprises identifier detail, location timestamp, frequencies of the wireless enabled objects, and information comprising a combination of at least one of the foregoing.

17. A method for detection and tracking of wireless enabled objects, comprising:
scanning and detecting wireless enabled objects by one or more wireless communication modules of a plurality of detectors;
collecting associated information about the wireless enabled objects;
sending the associated information to a central server; and
processing of associated information by the central server to produce analyzed data.

18. The method of claim 17, further comprising accessing the analyzed data at a user interface installed with a user application.

19. The method of claim 17, further comprising filtering the detected wireless enabled objects based on application for which the detection is to be used.

20. The method of claim 17, further comprising analyzing whether a detected object is out of coverage area of a detector of the plurality of detectors.

21. The method of claim 17, further comprising receiving, sending and processing messages of a user by the plurality of detectors and the central server.

22. A system for detection and tracking of wireless enabled objects, comprising:
a plurality of detectors capable of detecting one or more wireless objects and storing the associated information in a memory of each of the detectors.

23. The system of claim 22, wherein the memory is a removable memory unit that can be dynamically installed and removed and processed on a server for producing analyzed data.

24. The system of claim 22, wherein a wireless enabled device passing by a detector can retrieve the associated information from the memory of the detector.

25. The system of claim 22, further comprising a central server in operative communication with the plurality of detectors, wherein the central server is capable of receiving and processing the associated information to produce analyzed data.
